(19) United States
(12) Patent Application Publication
(10) Pub. No.: US 2026/0017708 A1
(43) Pub. Date: Jan. 15, 2026

(54) PLATFORM FOR CREATING AND DEPLOYING CUSTOM BRANDED STOREFRONTS

(71) Applicants: Hussein Khazaal, San Jose, CA (US); Sidhesh Divekar, Milpitas, CA (US)

(72) Inventors: Hussein Khazaal, San Jose, CA (US); Sidhesh Divekar, Milpitas, CA (US)

(21) Appl. No.: 19/243,971

(22) Filed: Jun. 20, 2025

Related U.S. Application Data
(60) Provisional application No. 63/669,922, filed on Jul. 11, 2024.

(51) Int. Cl. G06Q 30/0601

(52) U.S. Cl. CPC G06Q 30/0641; G06Q 30/0603

(57) ABSTRACT

The present disclosure provides a platform for creating and deploying custom branded storefronts. The platform comprises a processor and a memory storing instructions that, when executed by the processor, cause the processor to integrate with an application programming interface (API) of a cloud marketplace to retrieve product listing information, generate a customizable storefront interface for displaying selected product listings, implement an artificial intelligence (AI) assistant for automating content generation and providing real-time support, and deploy the customized storefront with a unique URL.

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

Trademarks used in the disclosure of the invention, and the applicants, make no claim to any trademarks referenced.

### CROSS-REFERENCE TO RELATED APPLICATIONS

This application claims priority to U.S. Provisional Application No. 63/669,922, filed Jul. 11, 2024, which is hereby incorporated by reference in its entirety.

### BACKGROUND OF THE INVENTION

### 1) Field of the Invention

The present disclosure relates to online retail platforms, and more particularly to a platform for creating and deploying custom branded storefronts that integrate product and service listings from multiple cloud marketplaces.

### 2) Description of Related Art

The rise of B2B marketplaces has revolutionized digital commerce, offering significant opportunities for businesses to enhance their operations and growth. Unlike traditional eCommerce models, B2B marketplaces allow third-party sellers to offer products directly to end customers, streamlining procurement and fostering profitable growth. This model enhances engagement for both buyers and sellers, simplifies buying and selling processes, and increases efficiency. Cloud marketplaces, such as AWS Marketplace, Microsoft Azure Marketplace, and Google Cloud Platform Marketplace, have further advanced this trend by offering centralized platforms for purchasing and managing cloud-based software and services. These platforms provide increased licensing flexibility, streamlined procurement, and improved vendor onboarding, resulting in substantial time and cost savings for buyers.

For sellers and channel partners, cloud marketplaces expand market reach, simplify sales processes, and open new revenue-sharing opportunities. Sellers benefit from a global customer base and reduced administrative overhead, while channel partners can offer value-added services and earn commissions. Additionally, there is a growing need to build custom branded storefronts that serve as eCommerce sites for enterprise software listed on these cloud marketplaces. These storefronts allow businesses to showcase their unique offerings, enhance brand recognition, and provide a tailored shopping experience for enterprise customers. According to studies like the AWS Marketplace Total Economic Impact™ report, organizations see significant economic benefits, including a high return on investment (ROI) and rapid payback periods. As businesses increasingly recognize these advantages, the adoption and growth of cloud marketplaces, along with custom branded storefronts, are expected to continue driving efficiency, cost savings, and sustainable business growth across various industries.

Online retail has become increasingly complex with the proliferation of cloud-based marketplaces and services. Businesses seeking to establish an online presence often face challenges in creating cohesive storefronts that integrate products and services from multiple sources. This fragmentation can lead to inefficiencies in management, inconsistent branding, and suboptimal user experiences for both sellers and buyers.

Traditional e-commerce platforms typically focus on single-source inventory management, limiting the ability of businesses to leverage diverse product catalogs across multiple cloud marketplaces. This constraint can hinder growth opportunities and restrict the range of offerings available to potential customers. Additionally, the process of manually aggregating and managing listings from various sources can be time-consuming and prone to errors.

The rise of cloud computing has introduced new possibilities for scalable and flexible e-commerce solutions. However, many existing platforms lack the capability to seamlessly integrate with multiple cloud marketplaces, leaving businesses struggling to maintain a unified presence across different ecosystems. This fragmentation can result in inconsistent pricing, outdated product information, and difficulties in inventory tracking.

Furthermore, as businesses expand globally, they encounter challenges related to localization and customization of their online storefronts. Many current solutions offer limited options for tailoring the user interface, content, and functionality to specific markets or customer segments. This lack of flexibility can impede efforts to create personalized shopping experiences and hinder international growth strategies.

Another area of concern is the management of user roles and access controls within e-commerce platforms. As organizations grow and involve multiple stakeholders in their online operations, there is an increasing need for granular control over user permissions and data access. Many existing systems provide rudimentary role-based access control, which may not adequately address the complex organizational structures and security requirements of modern businesses.

The integration of artificial intelligence and machine learning technologies into e-commerce platforms presents both opportunities and challenges. While these technologies offer potential for enhanced personalization, automated content generation, and improved decision-making, their implementation within existing e-commerce frameworks can be complex and resource-intensive.

As the e-commerce landscape continues to evolve, there is a growing demand for solutions that can address these multifaceted challenges. Businesses are seeking platforms that can provide a unified approach to managing diverse product catalogs, streamline operations across multiple marketplaces, offer customization and localization capabilities, and leverage advanced technologies to enhance the overall shopping experience.

### BRIEF SUMMARY OF THE INVENTION

The instant invention in one form is directed to a seamless and efficient method for creating and deploying custom branded storefronts for enterprise software, hardware, and services listed on multiple cloud and non-cloud marketplaces and vendor management systems. Currently, channel partners, distributors, and software vendors face significant challenges in offering a curated buying experience on their websites. This process involves complex and time-consuming integration with cloud and non-cloud marketplace APIs, building and maintaining the necessary infrastructure, and ongoing management, which often requires a large team of developers. These challenges add friction and can hinder revenue growth for sellers and resellers. The instant invention addresses these issues by simplifying the creation, deployment, and management of branded storefronts, incorporating AI features such as an AI Assistant to automate content generation and provide real-time support, as well as automatic localization to enhance the user experience for both buyers and sellers globally. In another form, the invention also addresses the challenges faced by enterprise buyer organizations, which often struggle to manage a growing number of software, hardware, and service purchases across disparate procurement systems. These buyers typically operate within rigid ERP or procurement platforms that lack integration with cloud marketplaces, complicating vendor onboarding, approval workflows, and tracking of purchases. The instant invention provides a unified interface that enables buyers to centralize procurement across multiple marketplaces and vendors through a simplified storefront interface. This includes support for internal budgeting, approval routing, custom buyer catalogs, compliance checks, and spend analytics. By streamlining the procurement process through a configurable and AI-enhanced storefront layer, the invention reduces administrative overhead and improves visibility and control for large purchasing organizations.

The invention is a comprehensive platform for creating and deploying custom branded storefronts that host a catalog of product and service listings from multiple cloud and non-cloud marketplaces. It simplifies the process of storefront creation, integration, and management, enabling users to provide a seamless and efficient buying experience for enterprise software, hardware and services products.

According to an aspect of the present disclosure, a platform for creating and deploying custom branded storefronts is provided. The platform includes a computer readable medium including instructions which, when executed by a processor, cause the computer to carry out algorithms for creating and deploying the custom branded storefronts. The platform integrates with an application programming interface (API) of a cloud marketplace to retrieve detailed information about product listings. The detailed information includes logos, EULAs, product descriptions, reviews, marketing materials, pricing, support, and refund information. Users select which listings to display in their storefronts, customize the storefront's design, and deploy it.

According to other aspects of the present disclosure, the platform incorporates AI features to automate content generation and provide real-time support. The platform performs automatic localization to enhance the user experience for both buyers and sellers globally. The platform enables enterprise buyers to centralize procurement across multiple marketplaces and vendors. The platform tracks spending, enforces approval workflows, and maintains compliance using integrations with ERP and procurement platforms. The platform provides full visibility, control, and audit capabilities.

According to another aspect of the present disclosure, the platform includes an AI Assistant pre-trained on public and proprietary data related to cloud marketplaces and the storefront. The AI Assistant assists with content generation for listings by taking URLs, PDFs, and TXT files as input, and automatically fills out all necessary fields. The AI Assistant provides real-time support for both storefront visitors and admins through a conversational interface.

According to other aspects of the present disclosure, the platform includes the following features. The platform automatically translates the content on the website based on the buyer's preference and the seller's choice. The platform offers a mobile-friendly version for both admins and buyers. An admin dashboard allows users to customize the storefront's appearance without any coding. The platform deploys the customized storefront with a unique URL. Visitors can browse the catalog, add products to a shopping cart, and proceed to checkout. Admins can create filtering categories and tags. The platform suggests related products at checkout based on predefined links between products. Visitors can request to list their products, and admins can manage these requests. Admins can manage user access to specific listings and control the visibility of pricing information. The platform tracks visitor activities and logs data. Sellers can create and deploy multiple storefronts under the same organization. The platform generates private offers based on predefined templates and emails them to buyers. The platform supports SSO for user authentication. Admins can create product bundles and promotional packages.

According to another aspect of the present disclosure, the platform includes features designed for enterprise buyers involved in procurement, vendor management, and compliance. The platform integrates with leading procurement systems, enabling seamless synchronization of purchase requests, approvals, and purchase orders. Buyers gain access to a centralized dashboard for tracking software and services spending across multiple vendors and categories. Organizations can curate personalized catalogs for different teams or business units. The platform maintains a detailed history of user activity, quote requests, purchases, and approvals. Enterprise buyers can authenticate through Single Sign-On using identity providers. Custom approval flows can be configured per business unit or cost center. The platform integrates with ticketing systems to associate purchases with internal service requests or deployment tickets. Teams can collaborate within the platform by leaving comments, tagging colleagues, and attaching supporting documents. Large enterprises with multiple divisions can deploy separate storefront views per entity.

These and other objects, features, and advantages of the present invention will become more readily apparent from the attached drawings and the detailed description of the preferred embodiments, which follow.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1 illustrates a system diagram for creating and deploying custom branded storefronts, according to aspects of the present disclosure.

FIG. 2 illustrates a listing replication system for copying marketplace listings between seller accounts, according to an embodiment.

FIG. 3 illustrates a system architecture showing an AI-enabled application interface, according to aspects of the present disclosure.

FIG. 4 illustrates a linking diagram showing relationships between product sections in an online storefront system, according to an embodiment.

FIG. 5 illustrates a system diagram showing a platform architecture for custom branded storefronts, according to aspects of the present disclosure.

FIG. 6 illustrates a system diagram showing a distributed storefront architecture, according to an embodiment.

FIG. 7 illustrates a system architecture showing multiple storefront configurations and their interactions, according to aspects of the present disclosure.

FIG. 8 illustrates a system architecture for aggregating and managing data across multiple marketplaces and accounts, according to an embodiment.

FIG. 9 illustrates a system diagram showing a role-based access control implementation within a storefront environment, according to aspects of the present disclosure.

FIG. 10 illustrates a system architecture showing multiple system connectors and information exchange between different systems, according to an embodiment.

FIG. 11 illustrates a system diagram showing integration between a storefront system and various external systems, according to aspects of the present disclosure.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

As this invention is susceptible to embodiments of many different forms, it is intended that the present disclosure be considered as an example of the principles of the invention and not intended to limit the invention to the specific embodiments shown and described.

The invention is a comprehensive platform designed to create and deploy custom branded storefronts that host a catalog of product and service listings from multiple cloud marketplaces. The platform integrates with cloud marketplace APIs to retrieve detailed information about product listings, such as logos, EULAs, product descriptions, reviews, marketing materials, pricing, support, and refund information. Users can select which listings to display in their storefronts, customize the storefront's design, and deploy it with ease.

Features of the platform include:

### AI Assistant:

Pre-trained on public and proprietary data related to cloud marketplaces and the storefront. Assists with content generation for listings by taking URLs, PDFs, and TXT files as input, and automatically fills out all necessary fields.

Provides real-time support for both storefront visitors and admins (sellers) through a conversational interface.

### Localization:

Automatically translates the content on the website, including the main page, listings, and communications, based on the buyer's preference and the seller's choice.

Utilizes AI to perform translations based on browser input, geographical location, or manual user settings.

### Mobile Version:

Offers a mobile-friendly version for both admins (sellers) and buyers, allowing transactions through mobile devices with an optimized user interface.

### Custom Design & Deployment:

An admin dashboard allows users to customize the storefront's appearance (color themes, logos, banners, icons, font types) without any coding.

The platform deploys the customized storefront with a unique URL, either as a standalone website or embedded within an existing page.

### Shopping Cart & Checkout:

Visitors can browse the catalog, add products to a shopping cart, and proceed to checkout.

Checkout options include requesting a quote or logging in to a cloud account to subscribe directly to products.

### Tagging & Filtering:

Admins can create filtering categories and tags, enabling visitors to easily find and filter products.

### Linking & Recommendation Engine:

Suggests related products at checkout based on predefined links between products, enhancing cross-selling potential.

### List My Product & Cloning:

Visitors can request to list their products, and admins can manage these requests.

Cloning feature allows admins to replicate existing listings by retrieving information via API and auto-filling the listing creation form.

### Buyer Role-Based Access Control (RBAC):

Allows admins to manage user access to specific listings and control the visibility of pricing information.

### Analytics Module:

Tracks visitor activities and logs data, helping sellers improve the buying experience through data analysis.

### Deploy Multiple Storefronts:

Enables sellers to create and deploy multiple storefronts under the same organization, each with unique products, tags, users, and designs.

### Auto-Generated Private Offers:

Generates private offers based on predefined templates and emails them to buyers, simplifying the sales process.

### Single Sign-On (SSO):

Supports SSO for user authentication, integrating with third-party authentication applications.

### Create Promotions & Bundles:

Admins can create product bundles and promotional packages, offering discounts and additional services.

### 15. Vendor Bidding Interface:

Enables buyers to invite preferred vendors to the platform to list competitive product or service offerings.
Provides a centralized view for buyers to evaluate proposals and select the most suitable solution based on requirements, pricing, or strategic alignment.

### 16. Marketing-to-Sales Attribution:

Connects marketing efforts directly to sales outcomes by enabling storefronts to be linked to specific campaigns using unique UTM or campaign codes.
Tracks and attributes orders generated through each storefront back to the originating marketing campaign, closing the loop on ROI measurement.

### 17. Specialized AI Multi-Agent Framework:

Integrates AI-driven agents tailored for key enterprise functions, including sales development (SDR), CRM automation, and CSP workflow triggers.
Automates tasks such as lead qualification, meeting booking, and opportunity tracking-reducing manual effort and accelerating pipeline conversion while enhancing productivity across sales and partner teams.

Advantages over similar products include:

### Ease of Use:

The platform allows users to customize and deploy storefronts without writing any code, significantly reducing the time and technical resources required.

### Comprehensive Integration:

Seamlessly integrates with multiple cloud and non-cloud marketplaces, providing a unified solution for managing product listings.

Extends integration capabilities to major ERP systems (e.g., SAP, Oracle, NetSuite), enabling synchronization of financial, procurement, and supplier data across enterprise infrastructure.

Integrates with leading procurement platforms such as Coupa (spend management, invoicing, sourcing, and supplier collaboration) and SAP Ariba (supplier management, contract lifecycle, sourcing, and procurement orchestration), supporting automated purchasing, approvals, and compliance checks.

Connects with ticketing systems (e.g., ServiceNow, Jira Service Management, Zendesk) to automate issue tracking and tie support tickets directly to product or service transactions.

Links with top CRM platforms (e.g., Salesforce, HubSpot, Microsoft Dynamics) to unify customer engagement across sales, procurement, and support channels, enabling more intelligent co-sell and post-sale workflows.

### Advanced AI Features:

The AI Assistant and localization features offer unique capabilities that streamline content creation and enhance user experience.

### Efficiency:

Automates the integration and management processes, freeing up resources for business growth.

The platform achieves its purpose by automating and simplifying the process of creating, deploying, and managing branded storefronts. It leverages API integration to provide real-time data and seamless integration, ensuring that users can offer a curated and engaging shopping experience without the need for extensive technical resources.

The primary users of this platform are channel partners, distributors, technology vendors, managed service providers (MSPs), and value-added resellers (VARs) who wish to offer a branded and streamlined buying experience for enterprise software, hardware, and services on their websites. Additionally, the platform can be used by any business looking to simplify the management of their cloud marketplace listings across multiple marketplaces, vendor platforms, and procurement channels while improving customer engagement. The platform also serves enterprise buyers, including IT procurement teams, sourcing managers, finance departments, and operations teams, who require a centralized and efficient interface for evaluating, approving, and purchasing software applications, hardware solutions, and professional services across multiple vendors, marketplaces (including Amazon Business catalog for hardware products), and procurement channels. These buyers benefit from integrated workflows with internal enterprise systems such as ERP, procurement platforms, ticketing systems, and financial management tools, enabling improved spend management, vendor compliance, contract governance, and cross-departmental collaboration throughout the procurement lifecycle.

Main objectives of the platform include:

### Streamline Storefront Creation:

Reduce the complexity and time required to create and deploy branded storefronts.

### Enhance User Experience:

Provide a tailored and engaging shopping experience for buyers through advanced AI features and customization options.

### Increase Efficiency:

Automate integration and management processes to free up resources for business growth.

Empower Buyers with Procurement Control:

Allow enterprise buyers to manage procurement workflows, track software and service spending, and maintain seamless audit trails.

Integrate with ERP and procurement systems (e.g., SAP, Coupa, Ariba) to provide real-time visibility, compliance enforcement, and centralized control over purchasing activities.

### Expand Market Reach:

Enable sellers to reach a global customer base through a customizable and easy-to-manage storefront platform.

By addressing these objectives, the invention aims to drive efficiency, cost savings, and sustainable growth for businesses leveraging cloud marketplaces.

The invention offers several features that distinguish it from existing solutions for creating and managing branded storefronts for cloud marketplace listings:

### AI Assistant:

The AI Assistant is pre-trained on both public and proprietary data related to cloud marketplaces and the storefront. It provides a prompt-based assistant that answers questions using specific data, assisting both storefront visitors and admins (sellers).

It automates content generation for listings by taking URLs, PDFs, and TXT files as input, and automatically filling out all necessary fields. This significantly reduces the time and effort required to create listings.

### Advanced Localization:

The platform automatically translates the content on the website, including the main page, listings, and communications, based on the buyer's preference and the seller's choice. This AI-driven localization ensures that the storefront can cater to a global audience without requiring manual translation efforts.

### Real-Time Listing Management:

Users can view collected listings and select the ones they want to display in their branded storefront by simply checking a box on the listing tile. This real-time update capability ensures that the storefront content is always current and relevant.

Comprehensive Customization without Coding:

The admin dashboard allows users to customize the storefront's appearance, including color themes, logos, banners, icons, and font types, without any coding. This user-friendly interface makes it easy for non-technical users to create and manage their storefronts.

### Enhanced Shopping Cart and Checkout Experience:

The platform offers a sophisticated shopping cart and checkout system where visitors can add multiple products, adjust quantities, and request quotes or subscribe directly by logging into their cloud accounts. This seamless checkout process enhances the buyer experience and reduces friction during purchases.

### Tagging and Filtering System:

Admins can create filtering categories and tags, enabling visitors to easily find and filter products. This advanced tagging system allows for flexible and dynamic product categorization.

### Linking and Recommendation Engine:

The platform features a recommendation engine that suggests related products at checkout based on predefined links between products. This cross-selling capability can increase sales and provide a more personalized shopping experience.

### Automated Private Offer Generation:

The platform can automatically generate private offers based on predefined templates and email them to buyers. This automation streamlines the offer management process and ensures timely delivery of customized offers.

### Role-Based Access Control (RBAC):

The storefront supports RBAC, allowing admins to manage user groups and control access to specific listings and pricing information. This feature is for creating tailored experiences for different customer segments.

### Single Sign-On (SSO):

The storefront supports SSO, enabling users to log in using their corporate authentication systems. This integration simplifies the login process and enhances security for enterprise users.

### Mobile Version:

The storefront includes a mobile-friendly version for both admins (sellers) and buyers, allowing transactions through mobile devices with an optimized user interface. This ensures accessibility and usability across different devices.

### Promotions and Bundles:

Admins can create promotional packages and bundles of multiple products, offering discounts and additional services. This feature helps in marketing and upselling products, providing complete solutions to customers in a single click.

### Analytics and Data Collection:

The platform includes built-in analytics to track visitor activities and collect data on product interactions. This data helps sellers improve the buying experience and make informed decisions based on visitor behavior.

### Deploy Multiple Storefronts:

Sellers can create and deploy multiple storefronts under the same organization, each with unique products, tags, users, and designs. This flexibility allows businesses to target different customer segments with customized storefronts.

### Unified Intelligent Ecosystem:

Provides a single pane of glass that connects buyers, sellers, and resellers in a unified, AI-powered environment.
Enables seamless transactions using CSP (Cloud Solution Provider) committed spend programs.
Leverages AI-driven matching algorithms to intelligently align buyers with optimal sellers and partners, maximizing strategic fit, value realization, and operational efficiency across the marketplace.

In addition to supporting sellers and resellers, the invention includes a robust set of features designed to meet the needs of enterprise buyers involved in procurement, vendor management, and compliance. These features streamline internal purchasing workflows and improve visibility and control across the organization:

### Procurement Workflow Integration

Integrates with leading procurement systems such as SAP Ariba, Coupa, and Oracle Procurement Cloud, enabling seamless synchronization of purchase requests, approvals, and purchase orders. Buyers can transact directly through the storefront while ensuring data consistency with internal procurement policies.

### Spend Management and Analytics

Buyers gain access to a centralized dashboard for tracking software and services spending across multiple vendors and categories. Built-in analytics provide real-time reporting on spend by department, team, or project, supporting budgeting, forecasting, and audit readiness.

### Custom Buyer Catalogs and Role-Based Access

Organizations can curate personalized catalogs for different teams or business units, restricting product visibility and pricing based on role, department, or geographic region. This reduces procurement errors and ensures alignment with internal standards.

### Audit Trail and Compliance Controls.

The platform maintains a detailed history of user activity, quote requests, purchases, and approvals, supporting full audit trail compliance. Custom rules can be enforced to flag non-compliant transactions or require additional authorization for sensitive purchases.

### SSO and Identity Integration

Enterprise buyers can authenticate through Single Sign-On (SSO) using identity providers such as Azure AD, Okta, or Google Workspace. This ensures secure access while enabling role-based permissions for purchasing authority.

### Approval Routing and Budget Controls

Custom approval flows can be configured per business unit or cost center, including multi-level authorization and budget enforcement before purchases can be submitted or finalized.

### Support Ticket Linking

Integration with ticketing systems (e.g., ServiceNow, Jira) allows buyers to associate purchases with internal service requests or deployment tickets, improving IT coordination and traceability.

### Collaborative Procurement and Notes

Teams can collaborate within the platform by leaving comments, tagging colleagues, and attaching supporting documents to listings or quote requests, improving transparency and cross-functional input. Multi-Storefront Buyer Portals
Large enterprises with multiple divisions can deploy separate storefront views per entity, each with tailored catalogs, branding, and procurement workflows while maintaining centralized administrative oversight.

Compared to existing solutions, the invention stands out due to its comprehensive multi-marketplace integration, no-code customization, real-time listing management, advanced AI features, and robust analytics capabilities. These features collectively provide a seamless and efficient way to create and manage branded storefronts, significantly reducing the time and technical resources required, and enhancing both the seller and buyer experience. This invention uniquely addresses the complexities and inefficiencies associated with traditional storefront creation and management, offering a powerful solution for businesses looking to leverage cloud marketplaces to their full potential.

The invention is a comprehensive platform designed to create and deploy custom branded storefronts that host a catalog of product and service listings from multiple cloud marketplaces. It integrates with cloud marketplace APIs to retrieve detailed information about product listings, such as logos, EULAs, product descriptions, reviews, marketing materials, pricing, support, and refund information. Users can select which listings to display in their storefronts, customize the storefront's design, and deploy it with ease. The platform includes advanced AI features, localization, a mobile-friendly interface, and robust management tools to streamline the entire process.

Components of the Invention include:

### Catalog Integration Module:

Functionality: This module uses cloud marketplace APIs to ingest product listings from various cloud marketplaces such as AWS, Azure, and GCP. It retrieves detailed information including logos, EULAs, product descriptions, reviews, marketing materials, pricing, support, and refund information.

Process: The information is stored in a centralized database, allowing users to select listings for their branded storefront.

### Admin Dashboard:

Functionality: The admin dashboard is an intuitive interface that allows users to customize the storefront's appearance and manage content without any coding.

Customization Options: Users can select color themes, logos, banners, icons, and font types. They can also enter text for various messages such as welcome, error, checkout, request for private offers, and demo requests.

### Storefront Deployment Engine:

Functionality: This engine automates the deployment of the branded storefront with a custom URL, making it immediately functional.

Deployment Types: Users can choose to deploy the storefront as a standalone website or embed it within an existing page.

### Shopping Cart & Checkout System:

Functionality: This system allows visitors to browse the catalog, add products to the cart, and proceed to checkout.

Checkout Options: Visitors can request a quote by filling out a form or log in to their cloud account to subscribe to products directly.

### Tagging & Filtering System:

Functionality: This system enables admins to create filtering categories and tags to help visitors find products easily.

Process: Tags are applied to listings, which can then be filtered by visitors to narrow down their search.

### Recommendation Engine:

Functionality: The recommendation engine suggests related products at checkout based on links between products.

Link Management: Admins can create and manage links between products to enable cross-selling.

### Product Listing Management:

Functionality: Visitors can request to list their products on the storefront, and admins can manage these requests.

Cloning Feature: Admins can clone existing listings by retrieving information via API and auto-filling the listing creation form.

### Buyer Role-Based Access Control (RBAC):

Functionality: This feature allows admins to manage user access to specific listings and control the visibility of pricing information.

Group Management: Admins can create user groups, assign users to groups, and manage group permissions.

### Analytics Module:

Functionality: This module tracks visitor activities and logs data to help sellers improve the buying experience.

Data Usage: The data is analyzed to suggest improvements and create new product bundles.

### Multiple Storefront Management:

Functionality: Sellers can create and deploy multiple storefronts under the same organization, each with unique products, tags, users, and designs.

### Auto-Generated Private Offers:

Functionality: The platform can automatically generate private offers based on predefined templates and email them to buyers.

Process: When a visitor selects a product, the system generates a private offer and sends it to the buyer, who can log in to view and accept the offer.

### Single Sign-On (SSO):

Functionality: The storefront supports SSO for user authentication, integrating with third-party authentication applications.

Configuration: Admins configure SSO settings for specific user groups.

### Promotions & Bundles Creation:

Functionality: Admins can create packages and bundles of multiple products, offering discounts and additional services.

Promotional Tagging: Promotional messages and SKUs can be added to bundles, with automatic tagging for easy visitor access.

### AI Assistant:

Functionality: The AI Assistant is pre-trained on public and proprietary data related to cloud marketplaces and the storefront. It provides a prompt-based assistant that answers questions using the specific data provided. This assistant is available to both the storefront visitor and the admin (seller).

Listing Creation: The AI Assistant can take URLs, PDFs, and TXT files as input to automatically generate content and fill out all fields needed for the creation of the listing. The seller can use prompts to update the tone and content.

Conversational Interface: The seller can converse with the AI Assistant to retrieve information about the storefront, business, and transactions.

### Localization:

Functionality: The storefront automatically translates the content on the website, including the main page, listings, and communications, based on the buyer's preference and the seller's choice.

Translation Mechanism: This translation is performed using AI, based on input from the browser, geographical location, or manually set by the user.

### Mobile Version:

Functionality: The storefront includes a mobile-friendly version for both the admin (seller) and the buyer.

User Experience: Both buyers and sellers can transact through their mobile phones and devices, with a user interface optimized for different form factors compared to the desktop version.

### 17. Custom Listing & External Catalog Ingestion Module:

Functionality: This module allows users to manually create custom listings or automatically ingest product data from external third-party sources such as Amazon Business, Staples, and other vendor catalogs using available APIs or file-based integrations (e.g., CSV, XLSX, JSON).
Use Case: Buyers and procurement admins can enrich their storefronts with preferred vendor items beyond traditional cloud marketplaces, consolidating their purchasing view in a single interface.
Data Mapping: The platform normalizes data fields like SKU, pricing, images, descriptions, and vendor metadata to align with internal procurement and display standards.

### 18. Procurement Workflow Integration Module:

Functionality: This module integrates with ServiceNow, Coupa, Ariba, and similar procurement and ITSM platforms to support pre-purchase workflows including budget checks, manager approvals, compliance reviews, and audit logging.
Approval Routing: Buyers initiating a transaction can trigger approval workflows directly from the storefront, with status tracking and email notifications tied to their enterprise systems.
Outcome: This enables enterprise-grade procurement governance while preserving a modern self-service experience for internal teams.

### How the Components Work Together

### Integration and Customization:

The Catalog Integration Module retrieves product listings from multiple cloud marketplaces and stores them in the database.

Using the Admin Dashboard, users customize the storefront's appearance and select listings to display.

The Storefront Deployment Engine deploys the customized storefront with a unique URL.

### User Interaction:

Visitors browse the catalog, add products to the shopping cart, and use the Tagging & Filtering System to find specific products.

At checkout, the Recommendation Engine suggests related products, enhancing the cross-selling potential.

### Management and Analytics:

The Analytics Module tracks visitor activities, providing data to improve the buying experience.

Multiple storefronts can be managed under the same organization, each with tailored content and design.

### Private Offers and Promotions:

The Auto-Generated Private Offers feature generates customized offers for visitors, simplifying the sales process.

Admins create promotions and bundles to offer complete solutions, attracting more buyers.

### User Access and Security:

The RBAC system ensures that only authorized users have access to specific listings and pricing information.

The SSO integration enhances security and simplifies the login process for enterprise users.

### Alternative Methods to Achieve Similar Results

### Manual Integration:

Businesses could manually integrate with each cloud marketplace API and build custom tools for listing management. This method is labor-intensive and requires significant technical resources.

### Third-Party Services:

Companies could use third-party services to create and manage their storefronts. However, these services may not offer the same level of customization and integration as the invention.

### In-House Development:

Developing an in-house solution could achieve similar results, but it would require a large development team and substantial investment in time and resources.

### Outsourced Development:

Businesses could outsource the development of a custom storefront to a software development firm. While this may reduce the internal workload, it can be costly and may not provide the same level of control over the final product.

By automating and simplifying these processes, the invention offers a more efficient and scalable solution for creating and managing branded storefronts on cloud marketplaces.

### Features

Retrieve and Build a Catalog from Listings on Multiple Marketplaces:

Use cloud marketplace APIs to ingest the entire list of product listings from multiple cloud marketplaces, retrieving information such as logos, EULAs, product descriptions, reviews, marketing materials, pricing, support, and refund information.

Store this information and provide the user with the ability to select listings to display in a branded storefront.

Users can view the collected listings and select the ones they want to show in their branded storefront by checking a box on the listing tile, which will push the selected listing to the branded storefront in real-time.

Users can filter listings to find specific products, use public listings from multiple marketplaces, including limited or private listings, and add new custom listings to the storefront.

### Custom Design & Deployment:

An admin dashboard allows users to select the color theme, deployment type (standalone website or embedded within an existing page), and enter text for various messages (welcome, error, checkout, request for private offers, request for demo, etc.).

Changes include logos, banners, icons, and font types without requiring any coding. Users select options, choose colors, and enter text messages, which are automatically deployed.

The platform deploys the branded storefront with a custom URL, making it fully functional immediately.

### Shopping Cart & Checkout:

Visitors can browse the catalog and add listings to the cart. Notifications confirm additions to the cart.

Visitors can view the cart, adjust quantities, and remove items.

At checkout, visitors have two options: request a quote (fill out a form with information sent to the storefront admin) or sign in to their cloud account to subscribe to the product directly.

### Tagging & Filtering:

The storefront admin can create filtering categories and tags, which are used to tag listings.

These tags enable visitors to filter the list of products in the storefront easily.

### Linking & Recommendation Functionality:

At checkout, visitors see a list of recommended solutions based on links between products.

Admins can create and manage links between products to enable cross-selling recommendations.

### List My Product & Cloning:

Visitors can request to list their products by filling out a form, with the option to provide a cloud marketplace URL or product details.

Admins receive email notifications and can create listings using the provided information.

Cloning allows sellers to replicate existing listings by retrieving information via API and auto-filling the listing creation form.

### Buyer Role-Based Access Control (RBAC):

The storefront has a login feature enabling visitors to see public listings. Logged-in users can see custom lists of products.

Admins can create and manage user groups, controlling access to specific listings and pricing information.

### Analytics:

The platform tracks visitor activities and logs data, helping sellers improve the buying experience through data analysis.

### Deploy Multiple Storefronts:

Sellers can create and deploy multiple storefronts under the same organization, each with unique products, tags, users, and designs.

### Auto-Generate Private Offers Based on Templates Mapped to Groups:

Admins can create private offer templates with fixed discounts. The system generates offers automatically and emails buyers, who can log in to view and accept the offers.

### Single Sign-On (SSO):

The storefront supports single sign-on (SSO) for user authentication, integrating with third-party authentication applications.

Admins configure SSO settings for specific user groups.

### Create Promotions & Bundles:

Admins can create packages and bundles of multiple products, offering discounts and additional services.

Promotional messages and SKUs can be added to bundles, with automatic tagging for easy visitor access. The system collects and anonymizes data on frequently purchased products, suggesting improvements and new bundle creations.

### AI Assistant:

The AI Assistant is pre-trained on public and proprietary data related to cloud marketplaces and the storefront. It provides a prompt-based assistant that answers questions using the specific data provided. This assistant is available to both the storefront visitor and the admin (seller).

When creating listings, the AI Assistant can take URLs, PDFs, and TXT files as input to automatically generate content and fill out all fields needed for the creation of the listing. The seller can use prompts to update the tone and content.

The seller can converse with the AI Assistant to retrieve information about the storefront, business, and transactions.

### Localization:

The storefront automatically translates the content on the website, including the main page, listings, and communications, based on the buyer's preference and the seller's choice.

This translation is performed using AI, based on input from the browser, geographical location, or manually set by the user.

### Mobile Version:

The storefront includes a mobile-friendly version for both the admin (seller) and the buyer.

Both buyers and sellers can transact through their mobile phones and devices, with a user interface optimized for different form factors compared to the desktop version.

### How the Components Work Together

### Integration and Customization:

The Catalog Integration Module retrieves product listings from multiple cloud marketplaces and stores them in the database.

Using the Admin Dashboard, users customize the storefront's appearance and select listings to display.

The Storefront Deployment Engine deploys the customized storefront with a unique URL.

### User Interaction:

Visitors browse the catalog, add products to the shopping cart, and use the Tagging & Filtering System to find specific products.

At checkout, the Recommendation Engine suggests related products, enhancing the cross-selling potential.

### Management and Analytics:

The Analytics Module tracks visitor activities, providing data to improve the buying experience.

Multiple storefronts can be managed under the same organization, each with tailored content and design.

### Private Offers and Promotions:

The Auto-Generated Private Offers feature generates customized offers for visitors, simplifying the sales process.

Admins create promotions and bundles to offer complete solutions, attracting more buyers.

### User Access and Security:

The RBAC system ensures that only authorized users have access to specific listings and pricing information.

The SSO integration enhances security and simplifies the login process for enterprise users.

### Alternative Methods

### Manual Integration:

Businesses could manually integrate with each cloud marketplace API and build custom tools for listing management. This method is labor-intensive and requires significant technical resources.

### Third-Party Services:

Companies could use third-party services to create and manage their storefronts. However, these services may not offer the same level of customization and integration as the invention.

### In-House Development:

Developing an in-house solution could achieve similar results, but it would require a large development team and substantial investment in time and resources.

By automating and simplifying these processes, the invention offers a more efficient and scalable solution for creating and managing branded storefronts on cloud marketplaces.

### Listing Management

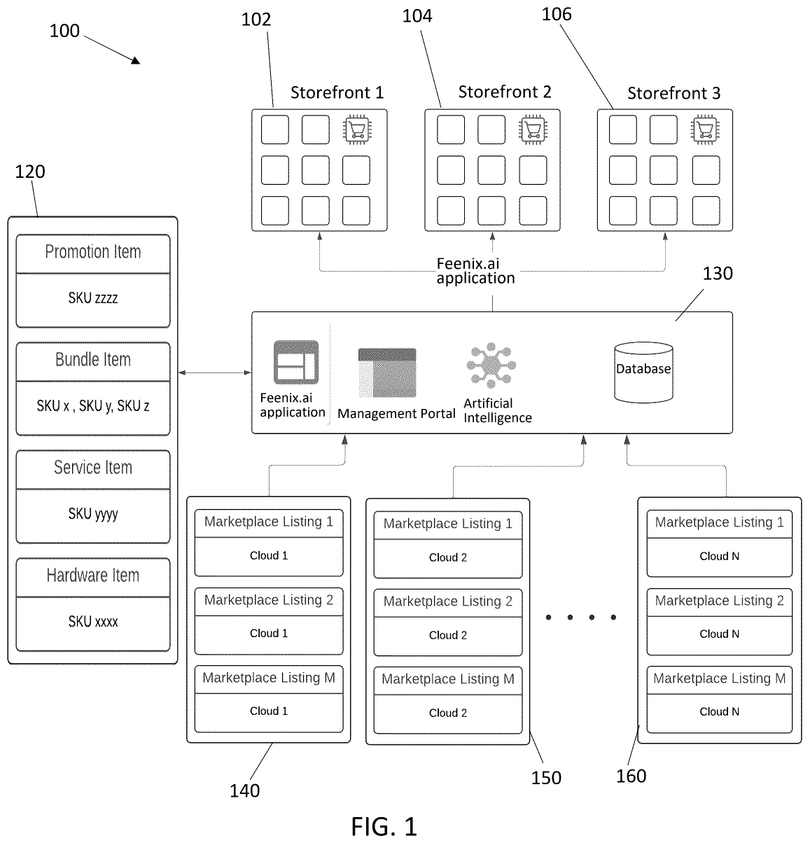

FIG. 1 is a diagram 100 of an overview storefront: A branded storefront that contains a user selected group of listings. These listings are in one more marketplaces and from different accounts or created on the storefront itself, which may include services, hardware, software that is not on a cloud marketplace or a bundle listing that consist of multiple products and services.

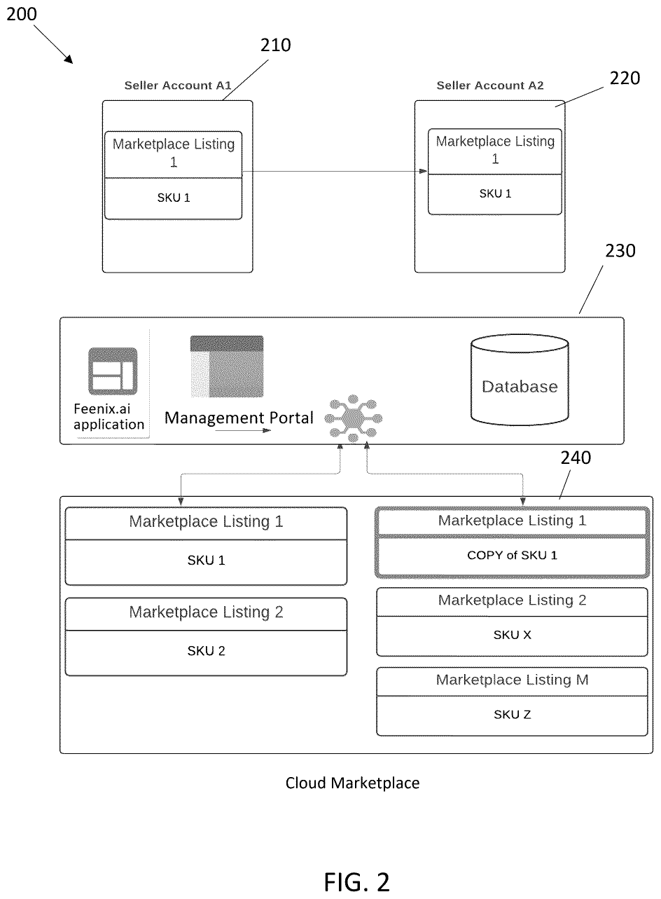

FIG. 2 shows a diagram 200 of a Cloning/Listing: Replicate/Clone a public or limited listing from one marketplace to another or between seller accounts in the same marketplace by pasting the link to the listing or by sharing the source listing with a second seller account.

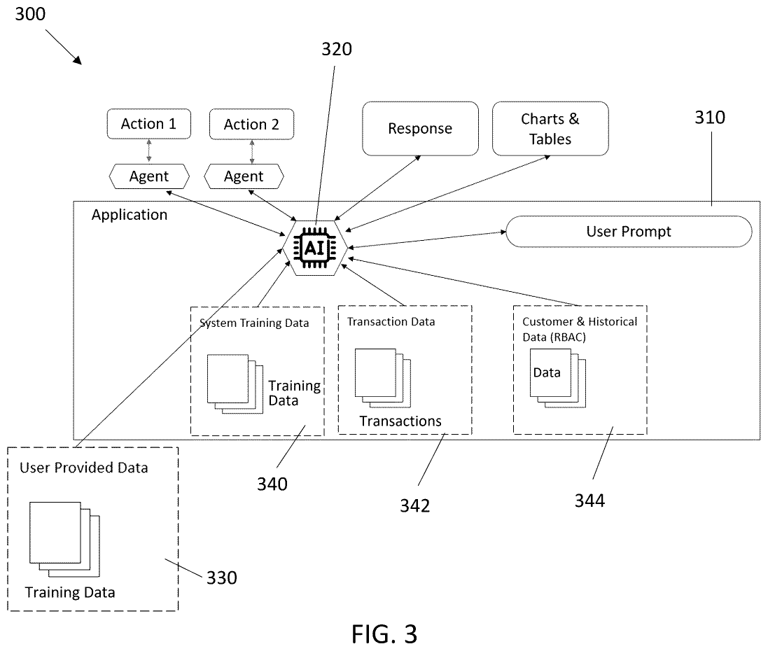

FIG. 3 shows a diagram 300 of an AI Assistant: The application provides a prompt for the user to provide responses to questions based on the different data sets that includes data from feenix.ai, data from the user that was uploaded, transaction data, and customer information). In addition to providing responses to queries, it can use AI-agents to complete actions such as create a listing, create a private offer, create a chart. Over time, the application will improve and learn more based on past experience to provide better responses. Also, the application will partition the data and certain users will have limited access based on their role.

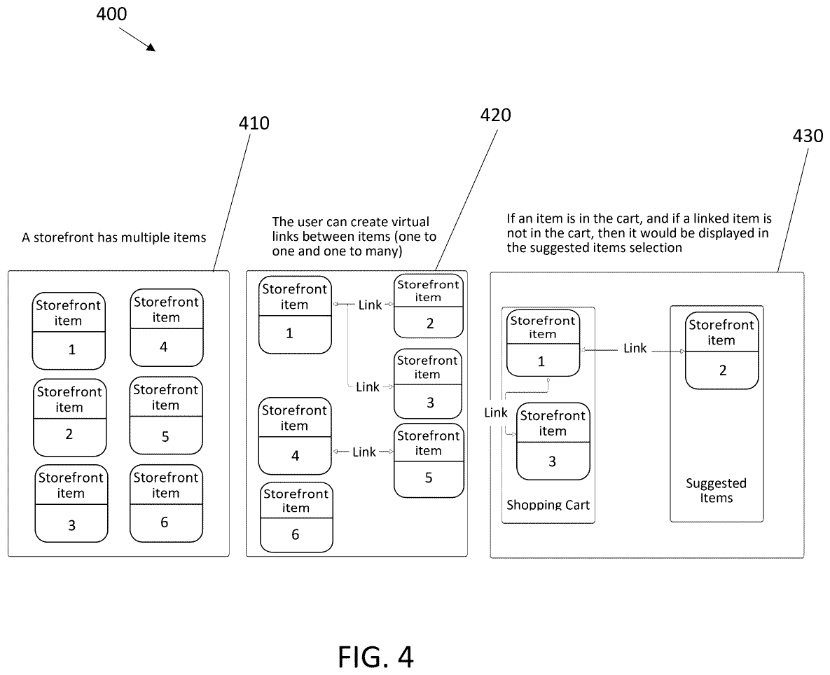

FIG. 4 is a diagram 400 showing linking performed in the platform: The checkout page will have a suggested products section that will highlight and recommend products that are not in the shoppers cart. The admin will create links between one or more products and the system will scan the cart and highlight missing linked products.

No-Code Deployment of buyer facing and branded storefronts: Using the application, the user can choose different designs, listings and filtering capabilities, then deploy one or more storefront. They can choose to deploy them on the platform as a virtual storefront with its own role-based access that will enable the buyer to see specific products based on their access. These deployed storefronts will have an AU-agent, analytics engine to track buyers and its own database. These instances can run on-premises or in the cloud.

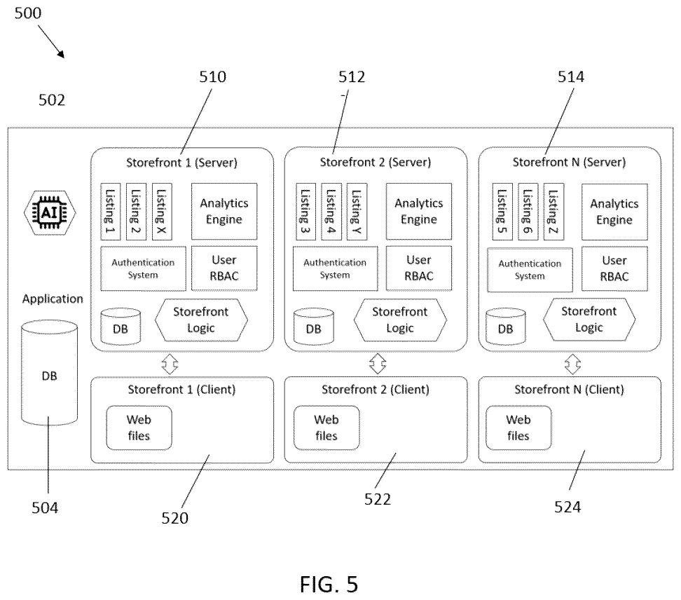

FIG. 5 is a diagram 500 showing version 1 of the platform (Client+Server hosted on the platform of the present invention)

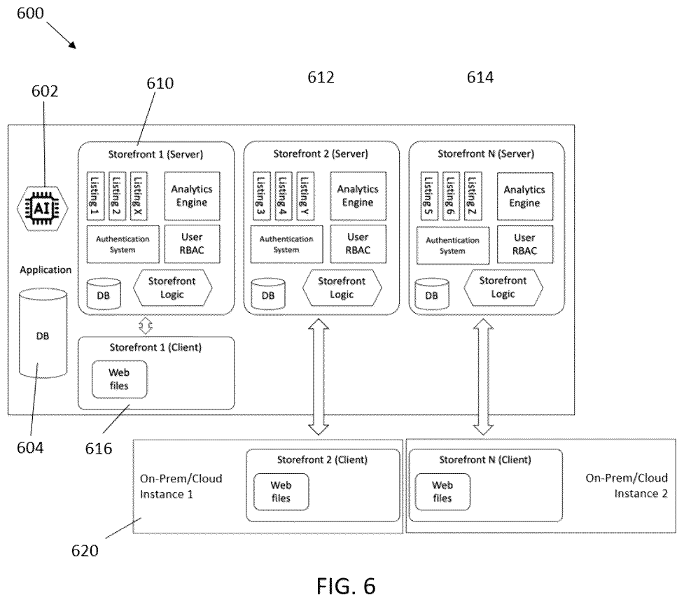

FIG. 6 is a diagram 600 showing version 2 of the platform (Client+Server hosted on the platform of the present invention); front end of client is deployed outside, but others are running on application.

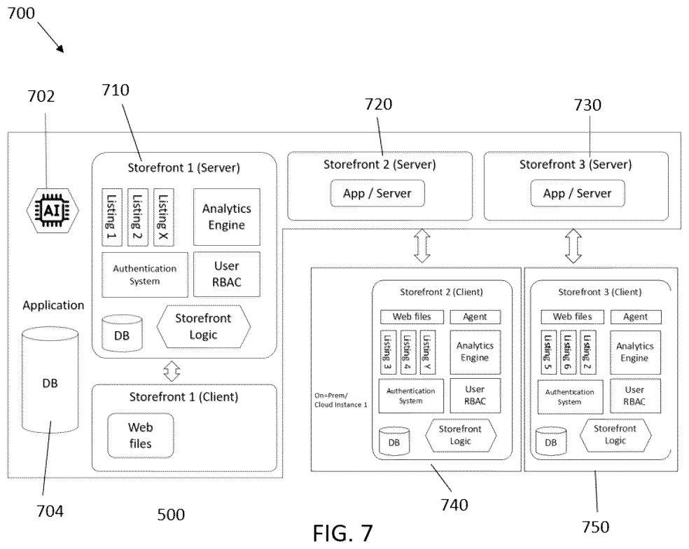

FIG. 7 is a diagram 700 showing version 3 of the platform (Client+Server hosted on the platform of the present invention); client is fully functional and only connects to server intermittently for updates and upgrades.

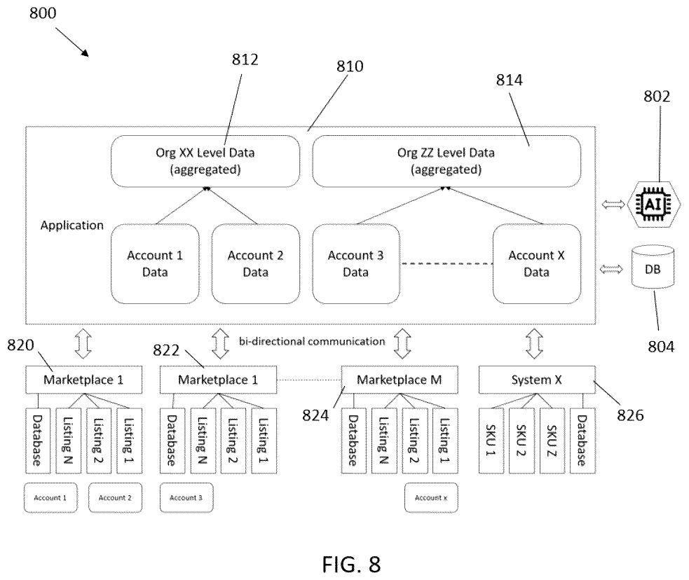

FIG. 8 shows a diagram 800 of Reporting aggregation for an org: An organization can have multiple accounts, each account can have its own seller reports and transactions. The application will aggregate reports from different accounts and provide the customer with an aggregated reports dashboard that can be filtered based on vendors, or other metadata fields. These filtered reports can then be exported or emailed to the user.

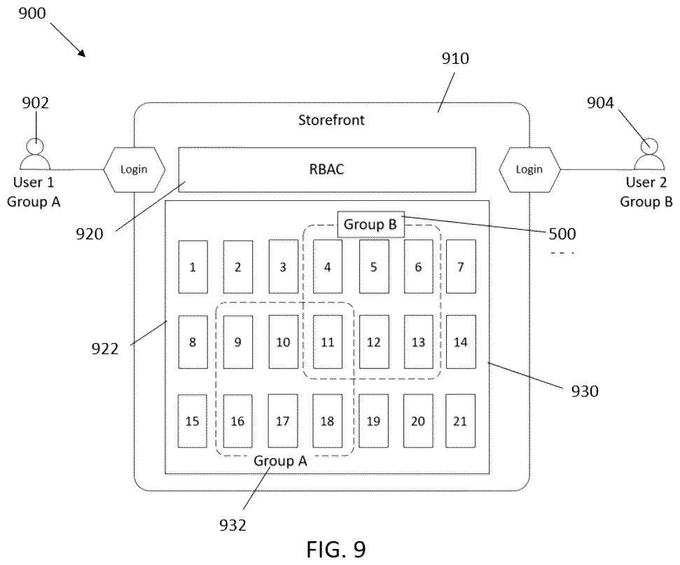

FIG. 9 is a diagram 900 showing Role-based access with segmentation for buyers: A seller can assign users to groups, each group provides access to a specific set of listings. The buyer that visits the store can only see the listings that belong to that group

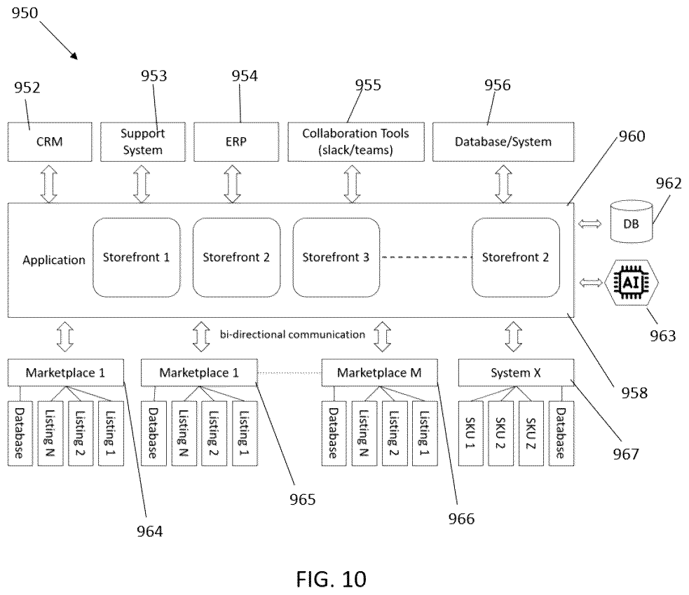

FIG. 10 is a diagram 950 showing multiple system connectors and exchange of information between these different systems. Application has connectors that connect to different systems finance, sales, marketing, and engineering systems and multiple marketplace systems. It exchanges data between systems, augments it with metadata and shares it across. It also provides dashboards that enable the customer to easily find and view and track information.

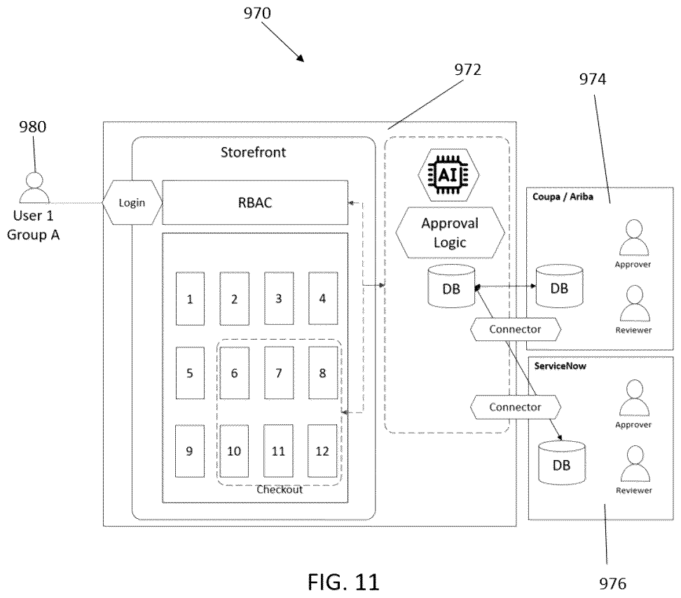

FIG. 11 illustrates a system diagram 950 showing integration with external ticketing and procurement systems to manage user requests and approval workflows. The platform includes pre-built connectors that enable seamless data exchange between procurement systems, ticketing tools, and various cloud marketplace environments. These integrations support the bidirectional flow of data, enriched with contextual metadata, to ensure consistent, real-time updates across platforms. This orchestration streamlines approval processes, facilitates compliance, and enables comprehensive purchase tracking and auditability.

One embodiment of the present invention includes a platform for creating and deploying custom branded storefronts for hosting a catalog of product and service listings from multiple cloud marketplaces. The platform includes a computer readable medium including instructions which, when executed by a processor, cause the computer to carry out algorithms for creating and deploying the custom branded storefronts. The platform integrates with cloud marketplace APIs to retrieve detailed information about product listings, such as logos, EULAS, product descriptions, reviews, marketing materials, pricing, support, and refund information wherein users can select which listings to display in their storefronts, customize the storefront's design, and deploy it with ease. The platform incorporates AI features to automate content generation and provide real-time support, as well as automatic localization to enhance the user experience for both buyers and sellers globally.

The present disclosure relates to a platform for creating and deploying custom branded storefronts. The platform enables users to host a catalog of product and service listings from multiple cloud marketplaces.

FIG. 1 illustrates a system diagram 100 showing an overview of the platform. The system diagram 100 includes a first storefront 102, a second storefront 104, and a third storefront 106. These storefronts are connected to a product catalog 120 and a management system 130. The management system 130 interfaces with first marketplace listings 140, second marketplace listings 150, and third marketplace listings 160.

The platform integrates with cloud marketplace APIs to retrieve detailed information about product listings. This information includes logos, EULAs, product descriptions, reviews, marketing materials, pricing, support, and refund information. Users can select which listings to display in their storefronts.

A key feature of the platform is the custom design and deployment capability. Users can customize the storefront's appearance without coding. This allows for easy creation of unique branded experiences tailored to specific business needs.

FIG. 5 illustrates a system diagram 500 showing the architecture for deploying multiple storefronts. The system diagram 500 includes an AI application interface 502 and an application database 504. These components support multiple storefront instances, represented by a first storefront server 510, a second storefront server 512, and an nth storefront server 514. Each storefront server has corresponding client components: a first storefront client 520, a second storefront client 522, and an nth storefront client 524.

This architecture enables users to deploy multiple storefronts under the same organization. Each storefront can have unique products, tags, users, and designs while maintaining centralized management through the AI application interface 502 and application database 504.

The platform incorporates AI features to enhance functionality. FIG. 3 illustrates a system architecture 300 that includes an AI application interface 320 connected to various data repositories: a user data repository 330, a system training repository 340, a transaction repository 342, and a customer data repository 344.

These AI capabilities assist with content generation and provide real-time support. The platform also offers automatic localization to improve the user experience for both buyers and sellers globally.

For enterprise buyers, the platform centralizes procurement across multiple marketplaces and vendors. It enables tracking of spending, enforcement of approval workflows, and maintenance of compliance. The system integrates with ERP and procurement platforms to streamline operations.

FIG. 11 illustrates a system diagram showing integration between the storefront system and external systems. The diagram includes an approval system 972, a procurement system 974, and a service system 976. These integrations provide full visibility, control, and audit capabilities, improving operational efficiency across departments.

The platform addresses challenges faced by enterprise buyer organizations in managing software, hardware, and service purchases across disparate procurement systems. By providing a unified interface, the system simplifies vendor onboarding, approval workflows, and tracking of purchases.

The system diagram 100 illustrates an overview of the platform for creating and deploying custom branded storefronts. The system diagram 100 includes the first storefront 102, the second storefront 104, and the third storefront 106. These storefronts are connected to the product catalog 120 and the management system 130.

The product catalog 120 contains various types of items including promotion items, bundle items, service items, and hardware items, each identified by their respective SKU numbers. The management system 130 includes a management portal, artificial intelligence capabilities, and a database for processing and storing information related to the storefronts and product listings.

The management system 130 interfaces with multiple marketplace listings arranged in different cloud environments. These include the first marketplace listings 140, the second marketplace listings 150, and the third marketplace listings 160. Each marketplace listing section contains multiple listing entries organized by cloud provider.

The system enables communication between the storefronts (102, 104, 106) and the management system 130, which in turn coordinates with the marketplace listings (140, 150, 160). This architecture allows for the aggregation and management of product listings from multiple cloud marketplaces into customized storefronts.

A system connector 958 facilitates the integration of various modules within the platform. These modules include a CRM module 952, a support system module 953, an ERP module 954, a collaboration tools module 955, and a database system module 956. The system connector 958 enables seamless data exchange between these modules and the storefront components.

The platform incorporates an AI processor 963 that enhances functionality across the system. The AI processor 963 is pre-trained on public and proprietary data related to cloud marketplaces and storefronts, enabling it to assist with content generation and provide real-time support for both storefront visitors and administrators.

An automatic localization feature is implemented within the system architecture. This feature translates content on the storefronts, including main pages, listings, and communications, based on buyer preferences and seller choices. The localization is performed using AI-driven algorithms that consider factors such as browser input, geographical location, or manual user settings.

The platform includes a mobile version for both administrators (sellers) and buyers. This mobile-friendly interface allows transactions through mobile devices with an optimized user experience, ensuring accessibility across different devices.

A tagging and filtering system is incorporated into the storefront interface 960. This system enables easy product discovery by allowing administrators to create filtering categories and tags. Visitors can use these tags to efficiently find and filter products within the storefront.

The system includes a shopping cart and checkout feature. A shopping cart section 420 allows visitors to add multiple products and adjust quantities. The checkout process provides options for requesting quotes or direct subscription to products by logging into cloud accounts.

A listing grid 930 displays product listings in an organized format. The listing grid 930 works in conjunction with a group segment 932 that defines specific areas accessible to different user groups, implementing role-based access control for product visibility.

The system architecture incorporates multiple marketplace connectors, including a first marketplace connector 964, a second marketplace connector 965, and a third marketplace connector 966. These connectors facilitate the integration of listings from various cloud marketplaces, allowing for a diverse range of products and services to be offered through the custom branded storefronts.

The listing replication system 200 enables the copying of marketplace listings between seller accounts. FIG. 2 illustrates the listing replication system 200, which includes a first seller account 210 and a second seller account 220. Each seller account contains marketplace listings and associated SKUs.

A management interface 230 facilitates interaction between the seller accounts and includes a management portal and database for processing listing information. The management interface 230 connects to a cloud marketplace 240 that contains multiple marketplace listings organized in a hierarchical structure.

When a listing is replicated, the listing replication system 200 creates a copy of the original SKU while maintaining the relationship between the original and copied listings. The cloud marketplace 240 organizes the listings with each listing containing its associated SKU information.

The management interface 230 processes listing replication requests and manages data flow between the seller accounts and the cloud marketplace 240. This enables listings to be copied from one seller account to another while preserving essential product information and SKU details.

The listing replication system 200 streamlines the process of listing management and product distribution across different seller accounts within the cloud marketplace 240. This functionality allows for efficient management and duplication of marketplace listings.

In some cases, the system allows creation of promotions and bundles. Administrators can create product bundles and promotional packages, offering discounts and additional services. This feature helps in marketing and upselling products, providing complete solutions to customers.

The system includes a feature for visitors to request listing their products. Visitors can submit requests to list their products, and administrators can manage these requests through the management interface 230. This functionality expands the range of products available in the marketplace and provides opportunities for new sellers to participate.

FIG. 3 illustrates a system architecture 300 showing an AI-enabled application interface. The system architecture 300 includes an AI application interface 320 that connects to multiple components and data repositories.

The AI application interface 320 interacts with a user interface module 310 that provides a User Prompt interface for interaction with the system. The user interface module 310 enables users to input queries and receive responses from the AI-enabled application.

The system architecture 300 incorporates several data repositories that provide information to the AI application interface 320. These repositories include a user data repository 330 containing training data, a system training repository 340, a transaction repository 342, and a customer data repository 344 that stores customer and historical data with Role-Based Access Control (RBAC).

The AI application interface 320 processes inputs received through the user interface module 310 and generates different types of outputs including Response outputs and Charts & Tables. The AI application interface 320 coordinates data flow between the various repositories and components, enabling the system to process information and generate appropriate responses based on the available data.

In some cases, the AI application interface 320 utilizes various agents that can perform Action 1 and Action 2. These agents are part of a specialized AI multi-agent framework designed for enterprise functions. The AI multi-agent framework automates tasks such as lead qualification, meeting booking, and opportunity tracking, enhancing productivity across sales and partner teams.

The system architecture 300 supports multi-storefront buyer portals for large enterprises. These portals allow enterprises with multiple divisions to deploy separate storefront views per entity, each with tailored catalogs, branding, and procurement workflows. The application interface 320 maintains centralized administrative oversight while enabling customized experiences for different enterprise divisions.

The AI application interface 320 accesses and utilizes information from all connected repositories to inform its operations and responses. This comprehensive data access allows the system to provide context-aware and data-driven outputs to user queries and actions.

The architecture allows for data exchange between components while maintaining appropriate access controls and data segregation. The customer data repository 344 with RBAC ensures that sensitive information is protected and only accessible to authorized users or processes within the system.

The system diagram 100 includes a linking diagram 400 that illustrates the product linking and recommendation system. FIG. 4 shows the linking diagram 400, which comprises a product listing section 410, the shopping cart section 420, and a suggested products section 430.

The product listing section 410 displays available items that users can select for purchase. When a user adds items to the shopping cart section 420, the system analyzes the contents of the cart to provide relevant product recommendations.

The suggested products section 430 interacts with the shopping cart section 420 to display related items that complement or enhance the products being purchased. This functionality enables cross-selling opportunities and improves the overall shopping experience for users.

The linking diagram 400 demonstrates how the system scans the contents of the shopping cart section 420 and highlights additional linked products in the suggested products section 430. These recommendations are based on predefined relationships between products, allowing for intelligent suggestions that are relevant to the user's current selections.

In some cases, the system incorporates a marketing-to-sales attribution functionality. This feature connects marketing efforts directly to sales outcomes by enabling storefronts to be linked to specific campaigns using unique UTM or campaign codes. The system tracks and attributes orders generated through each storefront back to the originating marketing campaign, providing valuable insights into the effectiveness of marketing strategies.

The product linking and recommendation system also supports auto-generated private offers based on predefined templates. The system can automatically generate private offers tailored to specific user preferences or shopping behaviors. These offers are then emailed to potential buyers, streamlining the sales process and providing personalized incentives to encourage purchases.

By implementing these features, the product linking and recommendation system enhances the user experience, increases cross-selling opportunities, and provides valuable data for marketing and sales optimization.

The system diagram 600 in FIG. 6 illustrates the storefront server and client architecture of the platform. The system diagram 600 includes an AI processor unit 602 and a database 604 that support multiple storefront server instances.

The architecture comprises a first storefront server 610, a second storefront server 612, and an nth storefront server 614. Each storefront server contains an analytics engine, authentication system, user Role-Based Access Control (RBAC), and storefront logic components. These servers connect to their respective databases and handle the backend processing for the storefronts.

A first storefront client 616 contains web files for the client-side interface. The system includes a cloud instance 620 that can host multiple storefront clients, labeled as “On-Prem/Cloud Instance 1” and “On-Prem/Cloud Instance 2.” These instances contain web files for their respective storefronts.

The architecture enables bidirectional communication between the storefront servers and their corresponding clients. The database 604 connects to the AI processor unit 602, which interfaces with the first storefront server 610. This structure allows for distributed deployment where the client components can be hosted separately from the server components while maintaining functional connectivity.

Each storefront server (610, 612, 614) maintains its own authentication system and analytics capabilities, allowing for independent operation while remaining part of the broader system architecture. The cloud instance 620 provides flexibility in deployment options for the client-side components.

The system supports Single Sign-On (SSO) for user authentication. This feature is implemented through the authentication system component present in each storefront server. SSO enables users to access multiple storefronts or services with a single set of credentials, enhancing user experience and security.

The system includes a vendor bidding interface for competitive product or service offerings. This interface is integrated into the storefront logic component of each storefront server. It allows vendors to submit competitive bids for products or services, fostering a dynamic marketplace environment within the platform.

An analytics module for tracking visitor activities is incorporated into each storefront server's analytics engine. This module collects and analyzes data on user interactions, page views, and transaction patterns. The collected data is stored in the database 604 and processed by the AI processor unit 602 to generate insights for improving the storefront performance and user experience.

The system architecture 700 in FIG. 7 further expands on the storefront configurations. It includes an AI processor 702 and a database system 704 that support the overall platform operations. This architecture showcases three storefront server configurations: the first storefront server 710, the second storefront server 720, and the third storefront server 730.

The second storefront client 740 and the third storefront client 750 represent different client-side implementations. Each client includes web files, an agent component, analytics engine, authentication system, user RBAC, and storefront logic modules. These clients maintain their own databases while connecting to their respective server counterparts (720, 730) for data synchronization and updates.

This architecture demonstrates the flexibility of the platform, allowing for various deployment configurations to suit different business needs. The AI processor 702 enhances the capabilities of the storefront servers and clients, providing advanced features such as personalized recommendations and automated content generation.

The system architecture 700 illustrated in FIG. 7 demonstrates multiple storefront configurations and their interactions within the platform. The system architecture 700 includes an AI processor 702 and a database system 704 that support the overall platform operations.

The system architecture 700 comprises three distinct storefront server configurations: the first storefront server 710, the second storefront server 720, and the third storefront server 730. Each server contains an App/Server component for processing and managing storefront operations.

The first storefront server 710 incorporates multiple elements including an analytics engine, authentication system, user Role-Based Access Control (RBAC), and storefront logic components. This server connects to a client portion containing web files for the user interface.

The second storefront client 740 and the third storefront client 750 represent different client-side implementations. Each client includes web files, an agent component, analytics engine, authentication system, user RBAC, and storefront logic modules. These clients maintain their own databases while connecting to their respective server counterparts (720, 730) for data synchronization and updates.

The system architecture 700 supports collaborative procurement and notes features. Users can collaborate within the platform by leaving comments, tagging colleagues, and attaching supporting documents to listings or quote requests. This functionality improves transparency and enables cross-functional input during the procurement process.

Buyer role-based access control (RBAC) is implemented for managing user access to specific listings. The user RBAC component present in each storefront server and client allows administrators to control access to listings based on user roles or groups. This feature ensures that users can only view and interact with listings appropriate to their role within the organization.

The system includes spend management and analytics features for tracking software and services spending. The analytics engine component in each storefront server and client collects and processes data related to purchases and expenditures. This data is then aggregated and analyzed to provide insights into spending patterns, helping organizations make informed decisions about their software and service investments.

The AI processor 702 enhances the capabilities of the storefront servers and clients by providing advanced features such as personalized recommendations and automated content generation. The database system 704 stores and manages the data required for the operation of all storefront instances, ensuring data consistency across the platform.

The system architecture 700 demonstrates the flexibility of the platform, allowing for various deployment configurations to suit different business needs. By supporting multiple storefront implementations with different levels of functionality, the system can accommodate a wide range of user requirements and operational scenarios.

The system architecture 800 illustrated in FIG. 8 shows a comprehensive data aggregation and management system for collecting and organizing information across multiple marketplaces and accounts. The system architecture 800 includes an artificial intelligence engine 802 and a database system 804 that support the overall data processing and storage operations.

The system architecture 800 comprises organization level data 810 which contains aggregated data from multiple sources. An aggregated data module 812 within the organization level data 810 collects and organizes information from multiple accounts. A data aggregation interface 814 facilitates the processing and organization of this data, ensuring efficient management of information across various sources.

A marketplace interface 820 enables interaction with different marketplaces, while a listing interface 822 manages product and service listings. These interfaces work in conjunction to gather and process data from multiple marketplace environments. A data exchange module 824 facilitates bi-directional communication between different system components, ensuring seamless data flow throughout the system.

A system interface 826 provides connectivity for external systems and services, allowing for integration with various enterprise tools and platforms. This integration capability supports procurement workflow integration with leading procurement systems such as SAP Ariba, Coupa, and Oracle Procurement Cloud. The system interface 826 enables seamless synchronization of purchase requests, approvals, and purchase orders between the storefront system and external procurement platforms.

The system architecture 800 incorporates audit trail and compliance controls features. The database system 804 maintains a detailed history of user activity, quote requests, purchases, and approvals. This comprehensive logging supports full audit trail compliance, allowing organizations to track and review all transactions and interactions within the system. Custom rules can be enforced to flag non-compliant transactions or require additional authorization for sensitive purchases, enhancing overall compliance management.

The system includes support ticket linking functionality, which integrates with external ticketing systems. This feature allows buyers to associate purchases with internal service requests or deployment tickets, improving IT coordination and traceability. The data exchange module 824 facilitates the connection between the storefront system and ticketing platforms such as ServiceNow or Jira, enabling seamless tracking of purchases in relation to support or deployment activities.

The artificial intelligence engine 802 enhances the capabilities of the data aggregation and management system by providing advanced analytics and insights. It processes the aggregated data to identify patterns, trends, and potential optimization opportunities across multiple marketplaces and accounts.

The system architecture 800 enables bi-directional communication paths between the marketplace components and the organizational data structure. Account data from multiple sources feeds into the aggregated data module 812, allowing for consolidated reporting and analysis. This structure supports data flow between various marketplaces, each containing their own listing and database components.

By implementing this comprehensive data aggregation and management system, the platform provides organizations with a centralized view of their marketplace activities, procurement processes, and compliance status. The integration of artificial intelligence, robust data exchange capabilities, and support for external system connections creates a powerful ecosystem for managing complex multi-marketplace operations.

The system diagram 900 in FIG. 9 illustrates the implementation of role-based access control (RBAC) within the storefront environment. The system diagram 900 includes a first user 902 designated as User 1 from Group A, and a second user 904 designated as User 2 from Group B. Each user connects to a storefront interface 910 through their respective login modules-a first login module 920 for User 1 and a second login module 922 for User 2.

The storefront interface 910 contains a listing grid 930 that displays numbered product listings arranged in a grid format from 1 to 21. Within this grid, a group segment 932 defines specific areas accessible to different user groups. The listings are segmented such that Group A and Group B have access to different sets of products within the grid.

The system implements role-based access control through these group segments, where users can only view and access the listings associated with their assigned group. This segmentation is managed through the RBAC layer shown in the storefront interface 910.

The RBAC implementation ensures that users from different groups or roles have appropriate access to product listings. For example, User 1 from Group A is granted access to a specific set of listings within the group segment 932, while User 2 from Group B is granted access to a different set of listings.

The login modules (920, 922) authenticate users and determine their group membership, which in turn defines their access rights within the storefront interface 910. This authentication process is crucial for maintaining the integrity of the RBAC system and ensuring that users only access authorized content.

The listing grid 930 dynamically adjusts its display based on the authenticated user's group membership. This dynamic adjustment ensures that users only see and interact with products and services relevant to their role or group within the organization.

In some cases, the system includes approval routing and budget controls features integrated with the RBAC implementation. These features allow organizations to set up custom approval flows configured per business unit or cost center. The approval routing includes multi-level authorization and budget enforcement before purchases can be submitted or finalized.

The RBAC implementation works in conjunction with the database system 804 and the AI processor 963 to manage and enforce access controls. The database system 804 stores user profiles, group memberships, and access rights, while the AI processor 963 assists in dynamically adjusting access based on user behavior and organizational policies.

The system connector 958 facilitates the integration of the RBAC implementation with other modules such as the CRM module 952, the support system module 953, and the ERP module 954. This integration ensures consistent access control across various aspects of the platform, including customer relationship management, support ticketing, and enterprise resource planning.

The data flow arrow 970 indicates the movement of information between the user group 980 and the storefront interface 910, representing the continuous exchange of authentication and authorization data that supports the RBAC implementation.

By implementing this comprehensive RBAC system, the platform provides organizations with granular control over user access to product listings, ensuring that users only interact with content appropriate to their role and responsibilities within the organization.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

Although very narrow claims are presented herein, it should be recognized that the scope of this invention is much broader than presented by the claim. It is intended that broader claims will be submitted in an application that claims the benefit of priority from this application.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A platform for creating and deploying custom branded storefronts, comprising:
a processor;
a memory storing instructions that, when executed by the processor, cause the processor to:
integrate with an application programming interface (API) of a cloud marketplace to retrieve product listing information;
generate a customizable storefront interface for displaying selected product listings;
implement an artificial intelligence (AI) assistant for automating content generation and providing real-time support; and
deploy the customized storefront with a unique URL.

2. The platform of claim 1, wherein the product listing information includes logos, end-user license agreements, product descriptions, reviews, marketing materials, pricing, support information, and refund policies.

3. The platform of claim 1, wherein the instructions further cause the processor to:
automatically translate content on the storefront based on a buyer's preference and a seller's choice.

4. The platform of claim 1, wherein the instructions further cause the processor to:
implement role-based access control to manage user access to specific listings and control visibility of pricing information.

5. The platform of claim 4, wherein the instructions further cause the processor to:
configure custom approval flows for purchases based on business unit or cost center.

6. The platform of claim 5, wherein the instructions further cause the processor to:
integrate with external procurement systems to synchronize purchase requests, approvals, and purchase orders.

7. The platform of claim 6, wherein the instructions further cause the processor to:
maintain an audit trail of user activity, quote requests, purchases, and approvals to support compliance requirements.

8. A method for creating and deploying a custom branded storefront, comprising:
integrating with an application programming interface (API) of a cloud marketplace to retrieve product listing information;
generating a customizable storefront interface for displaying selected product listings;
implementing an artificial intelligence (AI) assistant for automating content generation and providing real-time support; and
deploying the customized storefront with a unique URL.

9. The method of claim 8, wherein the product listing information includes logos, end-user license agreements, product descriptions, reviews, marketing materials, pricing, support information, and refund policies.

10. The method of claim 8, including automatically translating content on the storefront based on a buyer's preference and a seller's choice.

11. The method of claim 8, including implementing role-based access control to manage user access to specific listings and control visibility of pricing information.

12. The method of claim 11, including configuring custom approval flows for purchases based on business unit or cost center.

13. The method of claim 12, including integrating with external procurement systems to synchronize purchase requests, approvals, and purchase orders.

14. The method of claim 13, including maintaining an audit trail of user activity, quote requests, purchases, and approvals to support compliance requirements.

15. A non-transitory computer-readable medium storing instructions that, when executed by a processor, cause the processor to perform operations for creating and deploying a custom branded storefront, the operations comprising:
integrating with an application programming interface (API) of a cloud marketplace to retrieve product listing information;
generating a customizable storefront interface for displaying selected product listings;
implementing an artificial intelligence (AI) assistant for automating content generation and providing real-time support; and
deploying the customized storefront with a unique URL.

16. The non-transitory computer-readable medium of claim 15, wherein the operations include automatically translating content on the storefront based on a buyer's preference and a seller's choice.

17. The non-transitory computer-readable medium of claim 15, wherein the operations include implementing role-based access control to manage user access to specific listings and control visibility of pricing information.

18. The non-transitory computer-readable medium of claim 17, wherein the operations include configuring custom approval flows for purchases based on business unit or cost center.

19. The non-transitory computer-readable medium of claim 18, wherein the operations include integrating with external procurement systems to synchronize purchase requests, approvals, and purchase orders.

20. The non-transitory computer-readable medium of claim 19, wherein the operations include maintaining an audit trail of user activity, quote requests, purchases, and approvals to support compliance requirements.
